(19) United States
(12) Patent Application Publication
(10) Pub. No.: US 2024/0334958 A1
(43) Pub. Date: Oct. 10, 2024

(54) Method for Preparing Easy-to-Swallow Composite Gel based on High-pressure Shear Induction

(71) Applicant: Dalian Polytechnic University, Dalian (CN)

(72) Inventors: Xiuping DONG, Dalian (CN); Yisha Xie, Dalian (CN); Lin Han, Dalian (CN); Xiliang Yu, Dalian (CN); Xianda Du, Dalian (CN); Pengfei Jiang, Dalian (CN); Xuhui Huang, Dalian (CN); Beiwei Zhu, Dalian (CN)

(21) Appl. No.: 18/746,247

(22) Filed: Jun. 18, 2024

Related U.S. Application Data
(63) Continuation of application No. PCT/CN2023/095753, filed on May 23, 2023.

(30) Foreign Application Priority Data
May 30, 2022 (CN) 2022106005412

(51) Int. Cl. A23L 13/60; A23L 5/10; A23L 13/40; A23L 17/00; A23L 33/125; A23L 33/22; A23P 20/15; A23P 20/25

(52) U.S. Cl. CPC A23L 13/67; A23L 5/10; A23L 13/428; A23L 17/00; A23L 33/125; A23L 33/22; A23P 20/15; A23P 2020/253

(57) ABSTRACT

Disclosed is a method for preparing an easy-to-swallow composite gel based on high-pressure shear induction and belongs to the technical field of food processing. Marine products are used as raw materials. A cross-linking degree of thermally denatured proteins and a combination degree of functional oil are synchronously regulated, calculated and controlled by one-step of emulsion filling and protein cross-linking. A composite gel prepared has low strength, high water/oil retention rate and the properties of “soft” easy-to-swallow foods. The composite gel is enhanced in efficacy by nutrition regulation, and the prepared easy-to-swallow composite gel achieves precise nutrition regulation. The composite gel is differently shaped by 3D printing according to different people's needs to improve consumers' appetite for easy-to-swallow foods. The utilization rate of marine resources is fully improved, a fish meat base material can be prepared from leftover processed minced fish meat, so the added value of products is increased.

### TECHNICAL FIELD

The disclosure relates to a method for preparing an easy-to-swallow composite gel based on high-pressure shear induction, and belongs to the technical field of food processing.

### BACKGROUND

Since the beginning of the 21^{st} century, the number of elderly people in China has shown a rapid growth trend, and the degree of aging has further increased. With increasing age, the body's function gradually declines, leading to weakened chewing ability, tooth loss, insufficient saliva secretion, and other conditions. The conditions result in a decline in the chewing and swallowing function of most elderly people, limiting their food preference and reducing their appetite, and resulting in an important influence on their physical and mental health. Dietary guidelines for Chinese Residents for elderly people mainly recommends improving food diversity, making food delicate and soft, and paying attention to precise nutrition regulation. This promotes transformation of elderly dietary consumption from basic needs to nutrition and health, and development of suitable foods to meet the special physiological characteristics and nutritional needs of elderly people. The technology of improving food texture can reduce the incidence of swallowing disorders in most elderly people, and has been considered an effective means to improve the quality of life and ensure swallowing safety for elderly people with swallowing disorders. Therefore, to meet personalized dietary needs of consumers for special nutrition and texture, innovation in the processing technology of easy-to-swallow foods has become a research direction in society and the food industry.

### SUMMARY

The objectives of the disclosure are to overcome the disadvantages, such as difficulty for swallowing or esophageal retention, of existing functional foods, solve the problems such as instability of functional active substances in a protein-based gel, and provide a method for preparing an easy-to-swallow composite gel based on high-pressure shear induction. By the method, high-quality marine proteins are broken up and protein molecules are prompted to cross-link to form a high water retention network structure by high-pressure shearing. Also, oil containing functional active components is inlaid in the protein gel network, and finally a composite gel with a low gel strength (of 0.1-1.5 N or a storage modulus of 150-260 Pa) and a high water/oil retention rate (of greater than or equal to 90%) is obtained. The obtained composite gel is easy to swallow at room temperature, and can provide easy-to-swallow, high-nutritional, soft, gel-like foods for elderly people, patients with dysphagia and other special groups. The food can also be used as an additive to achieve personalized shape customization by 3D printing technology.

The first objective of the disclosure is to provide a method for preparing an easy-to-swallow composite gel based on high-pressure shear induction, including the following steps:
S1: cooking: cooking fish meat from raw fishes by heating to obtain cooked fish meat;
S2: prefabrication of fish meat: mixing the cooked fish meat obtained in step S1 with a salt solution, and washing and filtering the fish meat to obtain prefabricated fish meat;
S3: nutrition regulation of fish meat base: mixing the prefabricated fish meat obtained in step S2 with water, inulin and soybean dietary fiber to obtain a compound material, wherein a mass ratio of the prefabricated fish meat to the water to the inulin to the soybean dietary fiber is 1 kg: (1-3) kg: (0-200) g: (0-150) g;
S4: functionalization of oil: mixing liquid oil with oil-soluble nutrients to obtain functional oil; and
S5: one-step of emulsion filling and protein cross-linking: shearing the compound material obtained in step S3 at a high pressure, and adding the functional oil obtained in step S4 in the high-pressure shearing process to obtain a composite gel, wherein the pressure for performing the high-pressure shearing process is 20-100 MPa, each 100 g of the compound material is sheared at a high pressure for 4-15 min, and a mass ratio of the compound material to the functional oil is (85-90) g: (15-10) g.

In an embodiment, a solid-liquid ratio of the cooked fish meat to the salt solution in step S2 is 1:10 to 1:1,000 g/mL.

In an embodiment, the salt solution is a 0.01%-0.2% NaCl solution.

In an embodiment, in step S2, washing is performed at 40-70° C. 3-10 times for 1-5 min each.

In an embodiment, the raw fishes in step S1 could be cods or sturgeons, and cooking is performed by heating at 60-100° C. for 5-30 min.

In an embodiment, filtering in step S2 is performed using a 60-100-mesh filter cloth.

In an embodiment, the raw fishes in step S1 are fresh raw fishes that are slaughtered and promptly skinned, boned and eviscerated to obtain fish meat; if the slaughtered fish cannot be disposed of in time, the fishes are to be cooled at a low temperature to rapidly decrease the fish temperature, and then stored at a low temperature of 4-6° C.; after the fishes are completely stiff, the fishes are stored at around 0° C.; and if the fishes cannot be cooked in time after refrigeration, the fishes are to be frozen and stored at −80° C. to −20° C.

In an embodiment, the raw fishes in step S1 are fish meat of frozen raw fishes, and the frozen fishes are to be unfrozen, skinned, boned, and eviscerated to obtain the fish meat.

In an embodiment, the water in step S3 is pure water or mineral water.

In an embodiment, the oil-soluble nutrients in step S4 include but are not limited to vitamin E and carotenoids.

In an embodiment, the liquid oil in step S4 includes but is not limited to flaxseed oil and olive oil.

In an embodiment, a mixing ratio of the liquid oil to the oil-soluble nutrients in step S4 is 1 kg: (0.005-0.3) g.

In an embodiment, a mass ratio of the liquid oil to vitamin E to carotenoids in step S4 is 1 kg: (0.1-0.2) g: (0-0.06) g.

In an embodiment, the high-pressure shearing in step S5 is performed at 40 MPa, and each 100 g of the compound material is sheared at a high pressure for 9 min.

In an embodiment, step S5 is performed, followed by step S6 including: packaging, sterilizing, sealing and cooling the composite gel obtained in step S5 to room temperature to obtain an easy-to-swallow composite gel food.

In an embodiment, a container used for packaging in step S6 includes but is not limited to a metal can or a composite bag/can.

In an embodiment, the sterilization method in step S6 includes but is not limited to at least one of long-term low-temperature sterilization and irradiation sterilization; specifically, the long-term low-temperature sterilization is performed at 60-80° C. for 15-30 min; and the irradiation sterilization is performed at 1-10 kGy specifically.

In an embodiment, the easy-to-swallow composite gel food obtained in step S6 is stored at 2-10° C.

The second objective of the disclosure is to provide the easy-to-swallow composite gel prepared by the aforementioned method.

In an embodiment, the easy-to-swallow composite gel has a gel strength of 0.1-1.5 N, a storage modulus of 150-260 Pa, and a water/oil retention rate of not less than 98%. A 3D printed product of the easy-to-swallow composite gel has good precision and shape. The gastric half emptying time (t_{1/2}) of the easy-to-swallow composite gel is less than or equal to 150 min.

The third objective of the disclosure is to provide application of the easy-to-swallow composite gel in the field of 3D printing.

The application of the easy-to-swallow composite gel in 3D printing provided by the disclosure includes the following steps:
(1) printing: performing 3D printing using the aforementioned easy-to-swallow composite gel as a 3D printing material; and a printed solid gel was obtained;
(2) setting: setting the printed solid gel obtained in step (1) at 0-25° C. for 10-30 min to increase the elasticity and water retention of the easy-to-swallow composite gel.

In a preferred embodiment, in the 3D printing in step (1), the brand and model of a 3D printer is Shiyin Technology FoodBot-D2, the easy-to-swallow composite gel is guided into a feed cylinder of the 3D printer and printed by selecting model printing, a nozzle diameter is 0.8-1.8 mm, a printing speed is 15-30 mm/s, an extrusion force is 2-7 N, and an environmental temperature for printing is 4-25° C.

### Beneficial Effects of the Disclosure

1. The disclosure creatively provides a one-step of emulsion filling and protein cross-linking method, that is, the compound material is sheared at a high pressure, and the functional oil is added in the high-pressure shearing process to obtain the composite gel. By setting reasonable pressure and shearing time, the size of thermally denatured protein particles and the degree of cross-linking of the gel network are controlled. The high-quality marine proteins are broken up and the protein molecules are promoted to cross-link to form the high water holding capacity network structure by high-pressure shearing. Also, the functional oil is “inlaid” in the composite gel network structure, thereby embedding the fat-soluble nutrients, improving the water holding capacity of the composite gel, efficiently controlling the water/oil holding capacity to be greater than 90%, and improving the stability of the functional oil in the easy-to-swallow composite gel foods. By comprehensive regulation, the product has a gel strength of 0.1-1.5 N and a storage modulus of 150-260 Pa, is easy to swallow at room temperature, and can provide the easy-to-swallow, high-nutritional, soft, gel-like foods for elderly, dysphagia patients and other special groups. The disclosure overcomes the possible disadvantages, such as difficulty for swallowing or esophageal retention, of the existing functional foods, and solves the problems such as instability of the functional active substances in the protein-based gel.

2. In the disclosure, the cooked fish meat is washed in the salt solution to prefabricate the fish meat, which helps to reduce the pressure of subsequent high-pressure shearing, reduce energy consumption and increase the gel output.

3. Through a large number of experiments, the disclosure finds that the selection of the dietary fiber compounded with the fish meat may significantly affect the 3D printing performance of the composite gel product in the nutrition regulation step of the fish meat base: Based on the method of the disclosure, the composite gel prepared by specifically compounding a combination of the disclosure, i.e., the prefabricated fish meat, the water, the inulin and the soybean dietary fiber, in specific proportions, has good 3D printing performance, and the 3D printed product has good precision and shape, while a composite gel obtained by using chia seeds, quinoa flour or konjac gum is not suitable for 3D printing or difficult to successfully prepare a gel product.

4. The disclosure involves the nutrition regulation of the fish meat base, which improves the nutritional properties of the product. Also, the prepared composite gel has good 3D printing performance, and the 3D printed product has good precision and shape, and can still maintain high water/oil retention rate after 3D printing.

5. The disclosure fully improves the utilization rate of marine resources, and can use leftover processed minced meat and frozen preserved resources as raw materials to prepare easy-to-swallow foods, thereby increasing the added value of products.

6. In view of the requirements of gel additives in terms of efficient stability, special texture, and the like in a 3D printing materials, combined with 3D printing technology, the composite gel prepared by the disclosure is used as a 3D printing additive to meet consumers' needs for the nutrition, taste and appearance of foods, thereby improving the consumers' appetite, and achieving personalized shape customization of fish meat products.

### BRIEF DESCRIPTION OF FIGURES

FIG. 1 shows a microstructure of a composite gel prepared in Example 1 of the disclosure.

FIG. 2 shows real pictures of the composite gel prepared in Example 1 of the disclosure under the test and evaluation of International Dysphagia Diet Standardisation Initiative (IDDSI).

FIG. 3 shows real pictures of a composite gel prepared in Comparative Example 1 of the disclosure under the test and evaluation of IDDSI.

FIG. 4 is a real picture of a composite gel 3D printed product prepared in Example 2 of the disclosure.

FIG. 5A shows chyme states of samples prepared in Comparative Examples 2 of the disclosure, digested by a dynamic in vitro human stomach (DIVHS).

FIG. 5B shows chyme states of samples prepared in Comparative Examples 3 of the disclosure, digested by a dynamic in vitro human stomach (DIVHS).

FIG. 5C shows chyme states of samples prepared in Examples 3 of the disclosure, digested by a dynamic in vitro human stomach (DIVHS).

FIG. 5D shows chyme states of samples prepared in Examples 4 of the disclosure, digested by a dynamic in vitro human stomach (DIVHS).

FIG. 6 shows gastric retention ratio curves of the samples prepared in Example 4 and Comparative Examples 2 and 3 of the disclosure.

FIG. 7 is a real picture of a composite gel 3D printed product prepared in Comparative Example 6 of the disclosure.

FIG. 8 is a real picture of a composite paste 3D printed product prepared in Comparative Example 7 of the disclosure.

### DETAILED DESCRIPTION

### Test Methods:

Method for gel strength determination: A puncture test is performed using a P/0.5S probe, and the maximum force (N) induced when the probe penetrates to a gel for a depth of 15 mm is determined as the gel strength of a sample. A pre-test speed is set to 10.0 mm/s, a test speed is set to 1.0 mm/s, a post-test speed is set to 1.0 mm/s, and a triggering force is set to 3.0 g.

Method for storage modulus determination: An oscillation experiment is performed using a rotational rheometer and a parallel plate clamp (with a diameter of 40 mm) in a frequency scanning (Oscillation Frequency) mode, at a frequency of 0.1-100 rad/s to obtain the storage modulus of a sample.

Method for water/oil holding capacity determination by centrifugation: A sample is placed in a 10 mL centrifuge tube and centrifuged at 5,000 rpm at 4° C. for 10 min using a high-speed freezing centrifuge. The supernatant is removed and the weight of gel in the tube is recorded. The calculation formula is as follows:

$$water / oil holding capacity = ( {m}_{2} - {m}_{0} / ( {m}_{1} - {m}_{0} ) \times 100 \%$$

where m₀ is the mass of the empty centrifuge tube (g); m₁ is the total mass of the sample and the centrifuge tube (g); and m₂ is the total mass of the precipitate and the centrifuge tube after centrifugation (g).

Dynamic in vitro gastrointestinal digestion test: Gastrointestinal digestion is performed on different samples in a dynamic in vitro human gastrointestinal digestion system (DIVHS), and gastric emptying curves are made for comparative analysis. 100 g of a sample are mixed with an equal mass of artificial saliva in a food processor and the mixture is stirred at a low speed for 100 s to obtain food mass. The simulated food mass processed by the oral cavity is loaded into the DIVHS using a conical funnel and immediately start electromechanical equipment. 1 min before the sample enters the stomach, 30 mL of simulated gastric juice flows into an empty stomach model to simulate empty stomach digestion. The simulated gastric juice (purchased from Shanghai Yuanye Bio-Technology Co., Ltd.) is formulated according to the Chinese

Pharmacopoeia, and contains dilute hydrochloric acid, sodium chloride and pepsin (with an activity of 3,000 U/MG), with a pH of 1.2. Thereafter, a stomach roller presses the stomach model for 180 min, and a rate of a gastric peristalsis device is 500 mm/min. In the meantime, squeezed by a peristaltic pump, the simulated gastric juice is secreted into the stomach model, and the flow rate is shown in the table below. The sample gradually enters a simulated small intestine for digestion during gastric emptying, and the flow rate of a simulated intestinal juice is shown in the table below. The simulated intestinal juice (purchased from Shanghai Yuanye Bio-Technology Co., Ltd.) is formulated according to the Chinese Pharmacopoeia, and contains potassium dihydrogen phosphate, sodium hydroxide and trypsin (250 U/mg), with a pH of 6.8, based on which bile salt is added (with a final concentration of 2.6 mg/ml).

TABLE 1
Operating parameters of dynamic in vitro
human gastrointestinal digestion system
Operating parameters of gastric juice injection pump

| | | | | | | | | |
|---|---|---|---|---|---|---|---|---|
| Speed | 30 | 1 | 1.3 | 1.7 | 2.2 | 1.8 | 1.4 | 1.3 |
| mL/min | | | | | | | | |
| Time min | 1 | 10 | 10 | 10 | 10 | 10 | 10 | 120 |

Operating parameters of intestinal juice injection

| | | |
|---|---|---|
| Speed | 0 | 1.1 |
| mL/min | | |
| Time min | 1 | 240 |

Operating parameters of 1M HCl injection pump

| | | |
|---|---|---|
| Speed | 0 | 0.5 |
| mL/min | | |
| Time min | 1 | 40 |

Operation parameters of stomach rotation

| | | | | |
|---|---|---|---|---|
| Speed | 0 | 1 | 0 | −0.4 |
| °/min | | | | |
| Time min | 1 | 10 | 20 | 125 |

Operation parameters of stomach peristalsis

| | | |
|---|---|---|
| Forward | 500 | 500 |
| speed | | |
| mm/min | | |
| Return | 600 | 600 |
| speed | | |
| mm/min | | |
| Time min | 4 | 175 |

Operation parameters of small intestine

| | |
|---|---|
| Speed | 100 |
| mm/min | |
| Time min | 240 |

### Gastric Emptying Curve Test of Sample:

Samples (every 15 min from the stomach) during the digestion process of the DIVHS are taken, the samples are freeze-dried, and the digestive juices before and after drying are weighed. The proportion of dry matter content in the collections is calculated separately, i.e., the retention percentage (%) in the stomach during the digestion process of the sample. The gastric emptying conditions of the samples are described using an Elashoff's power-exponential model:

$$y ( t ) = 1 - {( 1 - {e}^{- k t} )}^{β} ) \qquad Eq . ( 1 )$$

Where y(t) is the fractional meal retention at time t in minutes; k is the gastric emptying rate per minute (1 per min), and ß is the extrapolated y-intercept from the terminal portion of the curve.

The half-time (t_{1/2}) of gastric emptying was calculated from Eq. (1) when y(t)=0.5:

$${t}_{1 / 2} = ( - 1 / k ) \times ln ( 1 - {0.5}^{1 / β} ) .$$

### Example 1

S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:50 (g/mL), the fish meat was washed at 60° C. 5 times for 1 min each, and the washed mixture was filtered using a 60-mesh nylon filter cloth to obtain prefabricated fish meat;
S3: nutrition regulation of fish meat base: the prefabricated fish meat obtained in step S2 was mixed with water, inulin and soybean dietary fiber to obtain a compound material, where a mass ratio of the prefabricated fish meat to the water to the inulin to the soybean dietary fiber was 1 kg: 1.4 kg: 160 g: 70 g;
S4: functionalization of oil: flaxseed oil and carotenoids were mixed in a mass ratio of 1 kg: 0.01 g to obtain functional oil; and
S5: one-step emulsion filling and protein cross-linking: the compound material obtained in step S3 was sheared at a high pressure, and the functional oil obtained in step S4 was added in the high-pressure shearing process to obtain a composite gel, where the pressure was 40 MPa, each 100 g of the compound material was sheared at a high pressure for 9 min, and a mass ratio of the compound material to the functional oil was 85 g: 15 g.

A test showed that the composite gel had a gel strength of about 0.5 N, a storage modulus of 166-260 Pa, and a water/oil retention rate of about 98%.

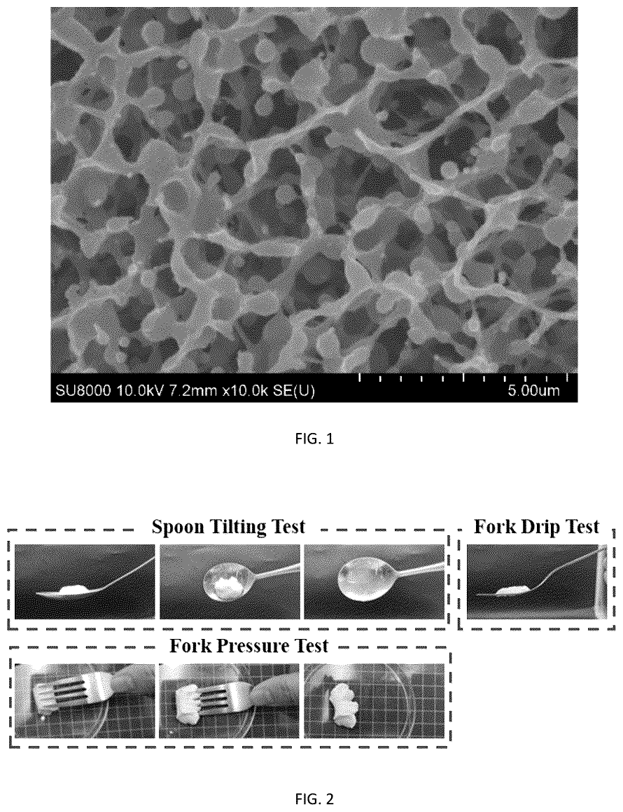

As shown in FIG. 1, the composite gel has a clear protein network structure, and the functional oil is evenly distributed in the network in the form of oil drops, demonstrating that the disclosure, by combining the one-step emulsion filling and protein cross-linking technology in step S5, successfully realizes construction of a protein gel network structure, and “inlays” the functional oil in the network structure synchronously.

As shown in FIG. 2, a spoon dripping test and a fork dripping test show that the composite gel can better maintain the original shape on the spoon; and a fork pressing test shows that the composite gel can be easily broken using the front end of the fork with weak force, without restoring the original shape, indicating that the composite gel constructed by the one-step emulsion filling and protein cross-linking technology in S5 of the disclosure meets the “soft” property in the standards of Easy-to-swallow Food, and is suitable for elderly people, children and other people with special needs for food texture.

### Example 2

S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:50 (g/mL), the fish meat was washed at 60° C. 5 times for 1 min each, and the mixture was filtered using an 80-mesh nylon filter cloth to obtain prefabricated fish meat;
S3: nutrition regulation of fish meat base: the prefabricated fish meat obtained in step
S2 was mixed with water, inulin and soybean dietary fiber to obtain a compound material, where a mass ratio of the prefabricated fish meat to the water to the inulin to the soybean dietary fiber was 1 kg: 1.4 kg: 120 g: 120 g;
S4: functionalization of oil: flaxseed oil and carotenoids were mixed in a mass ratio of 1 kg: 0.01 g to obtain functional oil;
S5: one-step emulsion filling and protein cross-linking: the compound material obtained in step S3 was sheared at a high pressure, and the functional oil obtained in step S4 was added in the high-pressure shearing process to obtain a composite gel, where the pressure was 40 MPa, each 100 g of the compound material was sheared at a high pressure for 9 min, and a mass ratio of the compound material to the functional oil was 90 g: 10 g;
S6: printing: 3D printing was performed using the composite gel obtained in step S5 as a 3D printing material, the brand and model of a 3D printer was Shiyin Technology FoodBot-D2, and the composite gel obtained in step S5 was guided into a feed cylinder of the 3D printer and printed by selecting model printing, where a nozzle diameter was 0.84 mm, a printing speed was 20 mm/s, an extrusion force was 2-7 N, and an environmental temperature for printing was 25° C.; and
S7: setting: the solid composite gel printed in step S6 was allowed to stand at 20° C. for 10 min to set to increase the elasticity and water retention of the composite gel.

A test showed that the composite gel obtained in step S5 of Example 2 had a gel strength of about 0.6 N, a storage modulus of 150-230 Pa, and a water/oil retention rate of about 98%.

As shown in FIG. 4, 3D printing of the composite gel obtained in step S5 of Example 2 may be achieved according to the shape of a design model, and a product obtained by 3D printing has good precision and shape, indicating that the composite gel prepared by the one-step emulsion filling and protein cross-linking technology in step S5 of the disclosure can be used as a 3D printing additive.

### Example 3

S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:100 (g/mL), the fish meat was washed at 60° C. 3 times for 3 min each, and the mixture was filtered using a 60-mesh nylon filter cloth to obtain prefabricated fish meat;
S3: nutrition regulation of fish meat base: the prefabricated fish meat obtained in step S2 was mixed with water to obtain a compound material, where a mass ratio of the prefabricated fish meat to the water was 1 kg: 1.4 kg; and
S4: one-step emulsion filling and protein cross-linking: the compound material obtained in step S3 was sheared at a high pressure, and flaxseed oil was added in the high-pressure shearing process to obtain a composite gel, where the pressure was 40 MPa, each 100 g of the compound material was sheared at a high pressure for 9 min, and a mass ratio of the compound material to the flaxseed oil was 90 g: 10 g.

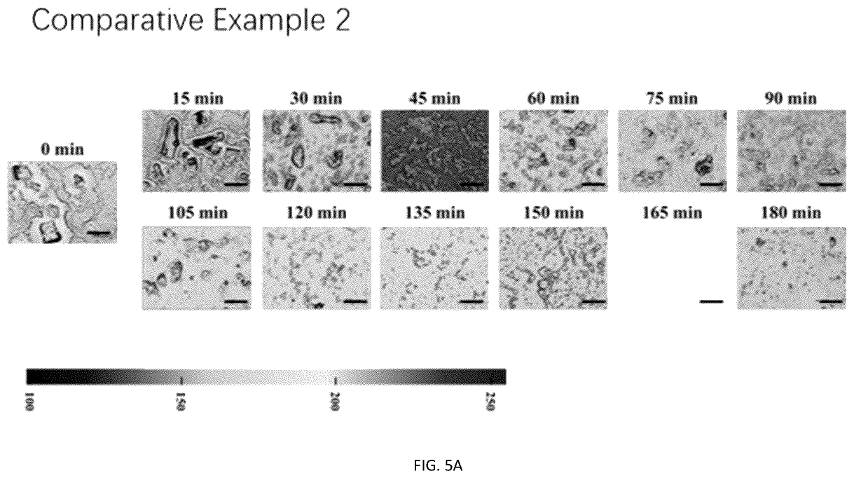

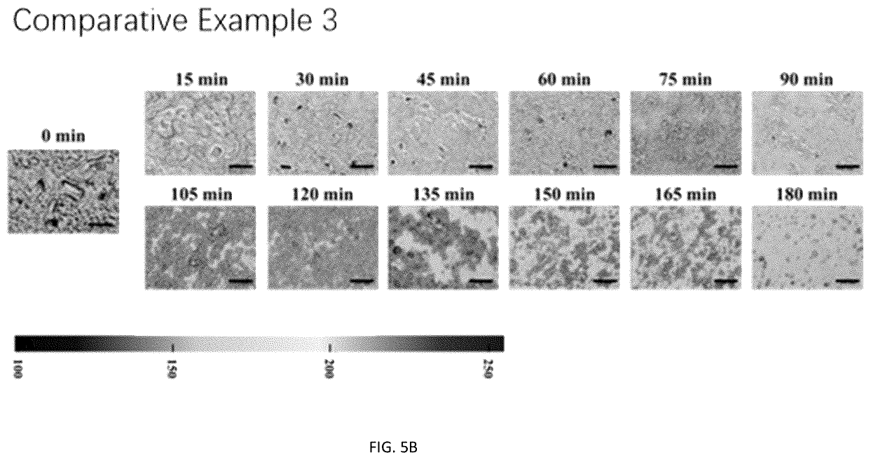

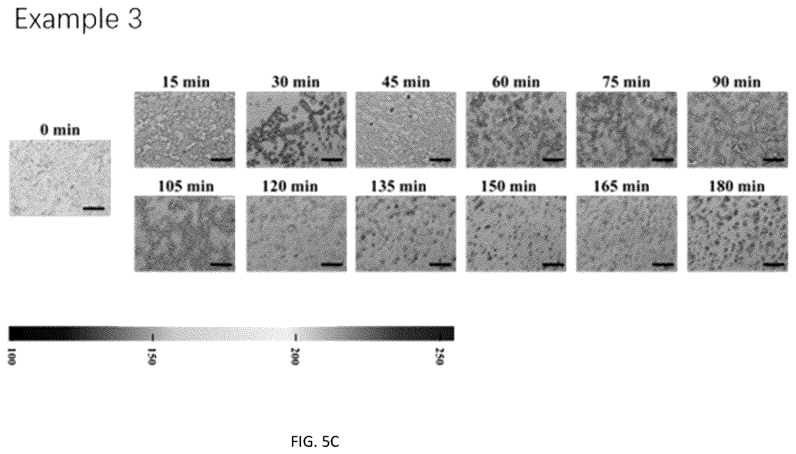

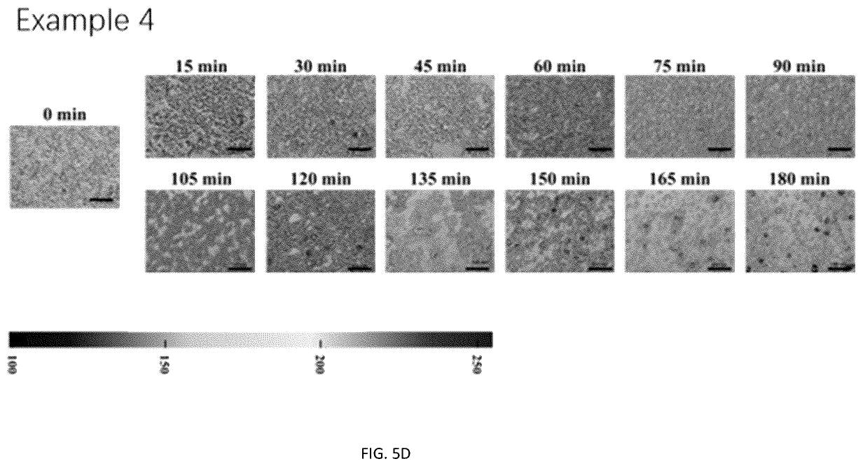

The composite gel prepared in Example 3 was subjected to a dynamic in vitro digestion test. As shown in FIG. 5C, at 0 min of digestion, it was observed under a microscope that the composite gel prepared in Example 3 had a compact structure, and the average particle size of the sample was less than 15 μm. As the digestion time prolonged, the particle size of the sample gradually decreased, and voids were observed on the surface of cod microfibers. In the late stage of digestion (180 min), it was observed that the particle size of digestive chyme of the composite gel of Example 3 significantly decreased, with an average particle size of 5.86 μm obtained by calculation and analysis.

### Example 4

S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:100 (g/mL), the fish meat was washed at 60° C. 10 times for 5 min each, and the mixture was filtered using a 100-mesh nylon filter cloth to obtain prefabricated fish meat;
S3: nutrition regulation of fish meat base: the prefabricated fish meat obtained in step S2 was mixed with water, inulin and soybean dietary fiber to obtain a compound material, where a mass ratio of the prefabricated fish meat to the water to the inulin to the soybean dietary fiber was 1 kg: 1.4 kg: 160 g: 70 g; and
S4: one-step emulsion filling and protein cross-linking: the compound material obtained in step S3 was sheared at a high pressure, and flaxseed oil was added in the high-pressure shearing process to obtain a composite gel, where the pressure was 40 MPa, each 100 g of the compound material was sheared at a high pressure for 9 min, and a mass ratio of the compound material to the flaxseed oil was 90 g: 10 g.

The composite gel prepared in Example 4 was subjected to a gastric emptying curve test. The composite gel prepared in Example 4 was subjected to a dynamic in vitro digestion test. As shown in FIG. 5D, at 0 min of digestion, the composite gel prepared in Example 4 was observed to have a compact structure under a microscope, and in the late stage of digestion (180 min), it was observed that the particle size of digestive chyme of the composite gel of Example 4 decreased to 5.36 μm.

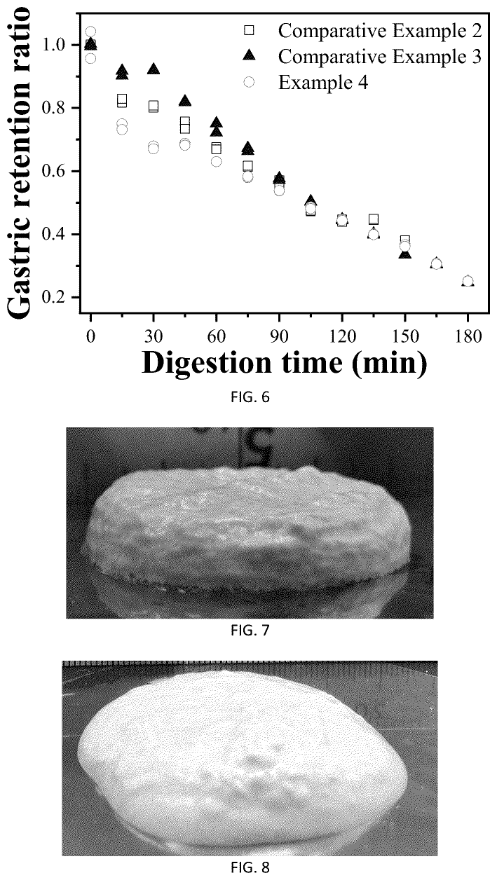

According to the gastric retention ratio curve in FIG. 6, the gastric half emptying time (t_{1/2}) of the composite gel of Example 4 was calculated to be about 93.80 min.

The tests showed that the composite gels obtained in Examples 1 to 4 had a low gel strength (0.1-1.5 N or a storage modulus of 150-260 Pa,) and a high water/oil retention rate (of greater than or equal to 90%). The obtained composite gels are easy to swallow at room temperature, and can provide easy-to-swallow, high-nutritional, soft, gel-like foods for elderly people, patients with dysphagia and other special groups. The food can also be used as a 3D printing additive to achieve personalized shape customization by 3D printing technology.

### Comparative Example 1

Referring to Example 1, except that the high-pressure shearing in step S5 was replaced with high-speed shearing.
S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:50 (g/mL), the fish meat was washed at 60° C. 5 times for 1 min each, and the mixture was filtered using a 60-mesh nylon filter cloth to obtain prefabricated fish meat;
S3: nutrition regulation of fish meat base: the prefabricated fish meat obtained in step S2 was mixed with water, inulin and soybean dietary fiber to obtain a compound material, where a mass ratio of the prefabricated fish meat to the water to the inulin to the soybean dietary fiber was 1 kg: 1.4 kg: 160 g: 70 g;
S4: functionalization of oil: flaxseed oil and carotenoids were mixed in a mass ratio of 1 kg: 0.01 g to obtain functional oil; and
S5: high-speed shearing: the compound material obtained in step S3 and the functional oil obtained in step S4 were sheared at high speed (at a shear rate of 3,000 rpm/min, for 9 min), where a mass ratio of the compound material to the functional oil was 85 g: 15 g, to try to prepare a composite gel.

It was found that the composite material obtained in step S5 was in the form of slurry, and could not be successfully prepared into a gel. Even if the shear rate, time and other parameters of high-speed shearing were optimized, the composite material still could not be successfully prepared into a gel.

A test showed that the obtained composite slurry had a storage modulus of 1.2-12 Pa, and a water/oil retention rate of about 65%.

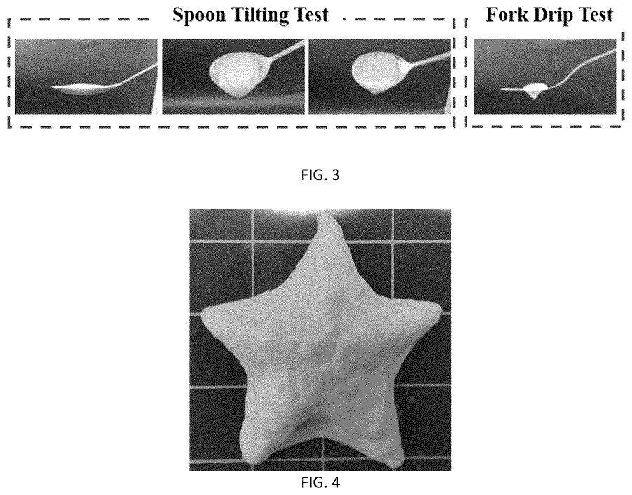

As shown in FIG. 3, the composite material prepared by high-speed shearing had fluidity and was in the form of a slurry. After the spoon was tilted, most of the sample fell off, and quite a big amount of sample remained on the surface of the spoon (obvious wall sticking property). The sample can easily flow through the gaps between the fork teeth, indicating that some of the sample may remain in the oral cavity during swallowing, which is not conducive for elderly people and other groups with swallowing disorders.

### Comparative Example 2

Referring to Example 4, except that the addition of inulin and soybean dietary fiber was omitted in nutrition regulation of fish meat base, and high-pressure shearing was replaced with high-speed shearing.
S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:100 (g/mL), the fish meat was washed at 60° C. 10 times for 5 min each, and the mixture was filtered using a 100-mesh nylon filter cloth to obtain prefabricated fish meat;
S3: nutrition regulation of fish meat base: the prefabricated fish meat obtained in step S2 was mixed with water to obtain a compound material, where a mass ratio of the prefabricated fish meat to the water was 1 kg: 1.4 kg; and
S4: high-speed shearing: the compound material obtained in step S3 and flaxseed oil were sheared at high speed (at a shear rate of 3,000 rpm/min, for 9 min), where a mass ratio of the compound material to the flaxseed oil was 90 g: 10 g, to try to prepare a composite gel. However, the sample state was similar to that of Comparative Example 1 in fluidity and did not have gel properties.

As shown in FIG. 5A, at 0 min of digestion, it was observed under a microscope that the composite material prepared in Comparative Example 2 had obvious fish meat fiber particles (with a size greater than 40 μm), and in the late stage of digestion (180 min), it was observed that the particle size of digestive chyme of the composite material of Comparative Example 2 decreased to 14.99 μm.

According to the gastric emptying curve in FIG. 6, the gastric half emptying time (t_{1/2}) of the composite material of Comparative Example 2 was calculated to be about 103.76 min.

### Comparative Example 3

S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:100 (g/mL), the fish meat was washed at 60° C. 10 times for 5 min each, and the mixture was filtered using a 100-mesh nylon filter cloth to obtain prefabricated fish meat;
S3: nutrition regulation of fish meat base: the prefabricated fish meat obtained in step S2 was mixed with water, inulin and soybean dietary fiber to obtain a compound material, where a mass ratio of the prefabricated fish meat to the water to the inulin to the soybean dietary fiber was 1 kg: 1.4 kg: 160 g: 70 g; and
S4: high-speed shearing: the compound material obtained in step S3 and flaxseed oil were sheared at high speed (at a shear rate of 3,000 rpm/min, for 9 min) to obtain a compound slurry, where a mass ratio of the compound material to the flaxseed oil was 90 g: 10 g, to try to prepare a composite gel. However, the sample state was similar to that of Comparative Example 1 in fluidity and did not have gel properties.

As shown in FIG. 5B, at 0 min of digestion, it was observed under a microscope that the composite material prepared in Comparative Example 3 had obvious fish meat fiber particles (with a size greater than that in Comparative Example 2), and in the late stage of digestion (180 min), it was observed that the particle size of digestive chyme of the composite material of Comparative Example 3 decreased to 10.13 μm. According to the gastric emptying curve in FIG. 6, the gastric half emptying time (t_{1/2}) of the composite material of Comparative Example 3 was calculated to be about 107.80 min.

### Comparative Example 4

Referring to Example 2, except that the one-step emulsion filling and protein cross-linking was replaced with a conventional process of first mixing materials and then performing high-pressure shearing.
S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:50 (g/mL), the fish meat was washed at 60° C. 5 times for 1 min each, and the mixture was filtered using an 80-mesh nylon filter cloth to obtain prefabricated fish meat;
S3: nutrition regulation of fish meat base: the prefabricated fish meat obtained in step S2 was mixed with water, inulin and soybean dietary fiber to obtain a compound material, where a mass ratio of the prefabricated fish meat to the water to the inulin to the soybean dietary fiber was 1 kg: 1.4 kg: 120 g: 120 g;
S4: functionalization of oil: flaxseed oil and carotenoids were mixed in a mass ratio of 1 kg: 0.01 g to obtain functional oil; and
S5: conventional high-pressure shearing: first the compound material obtained in step S3 was fully mixed with the functional oil obtained in step S4, and then sheared at high pressure to try to obtain a composite gel, where the pressure was 40 MPa, each 100 g of the compound material was sheared at a high pressure for 9 min, and a mass ratio of the compound material to the functional oil was 90 g: 10 g.

It was found that when the compound material and the functional oil were mixed first and then subjected to high-pressure shearing, a sample was agglomerated in the treatment process, causing blockage of an instrument; and a gel-like product could not be obtained.

### Comparative Example 5

Referring to Example 2, except that the compound material prepared from the prefabricated fish meat, the water, the inulin and the soybean dietary fiber was first sheared at a high pressure to prepare a protein gel, and then the protein gel and oil were sheared at a high pressure to try to prepare a composite gel.
S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:50 (g/mL), the fish meat was washed at 60° C. 5 times for 1 min each, and the mixture was filtered using an 80-mesh nylon filter cloth to obtain prefabricated fish meat;
S3: nutrition regulation of fish meat base: the prefabricated fish meat obtained in step S2 was mixed with water, inulin and soybean dietary fiber to obtain a compound material, where a mass ratio of the prefabricated fish meat to the water to the inulin to the soybean dietary fiber was 1 kg: 1.4 kg: 120 g: 120 g;
S4: high-pressure shearing: each 100 g of the compound material obtained in step S3 was sheared at a high pressure of 40 MPa for 5 min to obtain a protein gel;
S5: functionalization of oil: flaxseed oil and carotenoids were mixed in a mass ratio of 1 kg: 0.01 g to obtain functional oil; and
S6: preparation of composite gel: the protein gel obtained in step S4 was mixed with the functional oil obtained in step S5, and sheared at a high speed of 3,000 rpm/min for 4 min, where a mass ratio of the protein gel to the functional oil was 90 g: 10 g.

It was found that when the compound material was first sheared at a high pressure and then sheared with the functional oil, a sample prepared was a white paste with layering, and had a water/oil retention rate of less than 95%.

### Comparative Example 6

Referring to Example 2, except that the soybean dietary fiber was replaced with chia seeds.
S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:50 (g/mL), the fish meat was washed at 60° C. 5 times for 1 min each, and the mixture was filtered using an 80-mesh nylon filter cloth to obtain prefabricated fish meat;
S3: nutrition regulation of fish meat base: the prefabricated fish meat obtained in step S2 was mixed with water, inulin and chia seeds to obtain a compound material, where a mass ratio of the prefabricated fish meat to the water to the inulin to the chia seeds was 1 kg: 1.4 kg: 120 g: 120 g;
S4: functionalization of oil: flaxseed oil and carotenoids were mixed in a mass ratio of 1 kg: 0.01 g to obtain functional oil;
S5: one-step emulsion filling and protein cross-linking: the compound material obtained in step S3 was sheared at a high pressure, and the functional oil obtained in step S4 was added in the high-pressure shearing process to obtain a composite gel, where the pressure was 40 MPa, each 100 g of the compound material was sheared at a high pressure for 9 min, and a mass ratio of the compound material to the functional oil was 90 g: 10 g;
S6: printing: printing is performed using the composite gel obtained in step S5 as a 3D printing material; and
S7: setting: the solid composite gel printed in step S6 was allowed to stand at 20° C. for 10 min to set to increase the elasticity and water retention of the composite gel.

A test showed that the composite gel obtained in step S5 of Comparative Example 6 had a water/oil retention rate of about 98%. However, when the composite gel passed through a 3D printing nozzle, moisture separated out (as shown in FIG. 7), and 3D printed product had the shape of a design model but was unstable.

### Comparative Example 7

Referring to Example 2, except that the soybean dietary fiber was replaced with quinoa flour, and setting was performed at an appropriate temperature for an appropriate standing time.
S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:50 (g/mL), the fish meat was washed at 60° C. 5 times for 1 min each, and the mixture was filtered using an 80-mesh nylon filter cloth to obtain prefabricated fish meat;
S3: nutrition regulation of fish meat base: the prefabricated fish meat obtained in step S2 was mixed with water, inulin and quinoa flour to obtain a compound material, where a mass ratio of the prefabricated fish meat to the water to the inulin to the quinoa flour was 1 kg: 1.4 kg: 120 g: 120 g;
S4: functionalization of oil: flaxseed oil and carotenoids were mixed in a mass ratio of 1 kg: 0.01 g to obtain functional oil;
S5: one-step emulsion filling and protein cross-linking: the compound material obtained in step S3 was sheared at a high pressure, and the functional oil obtained in step S4 was added in the high-pressure shearing process to obtain a composite paste, where the pressure was 40 MPa, each 100 g of the compound material was sheared at a high pressure for 9 min, and a mass ratio of the compound material to the functional oil was 90 g: 10 g;
S6: printing: 3D printing is performed using the composite paste obtained in step
S5 as a 3D printing material; and
S7: setting: the solid composite paste printed in step S6 was allowed to stand at 4° C. for 10 min to set to increase the elasticity and water retention of the composite paste.

A test showed that the composite paste obtained in step S5 of Comparative Example 7 had a water/oil retention rate of about 98%, but was not in a gel state. When the composite paste was extruded through a 3D nozzle, a product printed did not have the shape of a design model and collapsed (as shown in FIG. 8).

### Comparative Example 8

Referring to Example 2, except that the soybean dietary fiber was replaced with konjac gum.
S1: cooking: thawed minced cod meat was cooked by heating to obtain cooked fish meat;
S2: prefabrication of fish meat: the cooked fish meat obtained in step S1 was mixed with a 0.1% NaCl solution in a solid-liquid ratio of 1:50 (g/mL), the fish meat was washed at 60° C. 5 times for 1 min each, and the mixture was filtered using an 80-mesh nylon filter cloth to obtain prefabricated fish meat;
S3: nutrition regulation of fish meat base: the prefabricated fish meat obtained in step S2 was mixed with water, inulin and konjac gum to obtain a compound material, where a mass ratio of the prefabricated fish meat to the water to the inulin to the konjac gum was 1 kg: 1.4 kg: 120 g: 120 g;
S4: functionalization of oil: flaxseed oil and carotenoids were mixed in a mass ratio of 1 kg: 0.01 g to obtain functional oil; and
S5: one-step emulsion filling and protein cross-linking: the compound material obtained in step S3 was sheared at a high pressure, and the functional oil obtained in step S4 was added in the high-pressure shearing process to obtain a composite paste, where the pressure was 40 MPa, each 100 g of the compound material was sheared at a high pressure for 9 min, and a mass ratio of the compound material to the functional oil was 90 g: 10 g.

It was found that the compound material stagnated in the high-pressure shearing process, which might be caused by the konjac gum and the fish meat cross-linking in the shearing process, reducing the fluidity, and resulting in stagnation of a machine in the high-pressure shearing process; and a gel-like product could not be obtained.

### Comparative Example 9

Referring to Example 1, except that uncooked minced fish meat was used.
S1: fish meat thawing: minced cod meat was thawed at 4° C. for 12 h to obtain fish meat;
S2: prefabrication of fish meat: the fish meat obtained in step S1 was mixed with a 0.1% NaCl solution in a solid-liquid ratio of 1:50 (g/mL), the fish meat was washed at 60° C. 5 times for 1 min each, and the washed mixture was filtered using a 60-mesh nylon filter cloth to obtain prefabricated fish meat;
S3: nutrition regulation of fish meat base: the prefabricated fish meat obtained in step S2 was mixed with water, inulin and soybean dietary fiber to obtain a compound material, where a mass ratio of the prefabricated fish meat to the water to the inulin to the soybean dietary fiber was 1 kg: 1.4 kg: 160 g: 70 g;
S4: functionalization of oil: flaxseed oil and carotenoids were mixed in a mass ratio of 1 kg: 0.01 g to obtain functional oil; and
S5: one-step emulsion filling and protein cross-linking: the compound material obtained in step S3 was sheared at a high pressure, and the functional oil obtained in step S4 was added in the high-pressure shearing process to obtain a composite sample, where the pressure was 40 MPa, each 100 g of the compound material was sheared at a high pressure for 9 min, and a mass ratio of the compound material to the functional oil was 85 g: 15 g.

It was found that the composite sample obtained by high-pressure shearing was still not in a gel state even after being refrigerated.

What is claimed is:

1. A method for preparing an easy-to-swallow composite gel based on high-pressure shear induction, comprising the following steps:
S1: cooking: cooking fish meat from raw fishes by heating to obtain cooked fish meat;
S2: prefabrication of fish meat: mixing the cooked fish meat obtained in step S1 with a salt solution, and washing and filtering the cooked fish meat to obtain prefabricated fish meat;
S3: nutrition regulation of fish meat base: mixing the prefabricated fish meat obtained in step S2 with water, inulin and soybean dietary fiber to obtain a compound material, wherein a mass ratio of the prefabricated fish meat to the water to the inulin to the soybean dietary fiber is 1 kg: (1-3) kg: (0-200) g: (0-150) g;
S4: functionalization of oil: mixing liquid oil with oil-soluble nutrients to obtain functional oil; and
S5: one-step emulsion filling and protein cross-linking: shearing the compound material obtained in step S3 at a high pressure, and adding the functional oil obtained in step S4 in the high-pressure shearing process to obtain a composite gel,
wherein the pressure for performing the high-pressure shearing process is 20-100 MPa, each 100 g of the compound material is sheared at a high pressure for 4-15 min, and a mass ratio of the compound material to the functional oil is (85-90) g: (15-10) g.

2. The method according to claim 1, wherein a solid-liquid ratio of the cooked fish meat to the salt solution in step S2 is 1:10 to 1:1,000 g/mL.

3. The method according to claim 1, wherein the salt solution is a 0.01%-0.2% NaCl solution.

4. The method according to claim 1, wherein in step S2, washing is performed at 40-70° C. 3-10 times for 1-5 minutes each.

5. The method according to claim 1, wherein the raw fishes in step S1 are cods or sturgeons, and cooking is performed by heating at 60-100° C. for 5-30 minutes.

6. The method according to claim 1, wherein the oil-soluble nutrients in step S4 comprise at least one of vitamin E and carotenoids.

7. The method according to claim 1, wherein the liquid oil in step S4 comprises flaxseed oil.

8. The method according to claim 1, wherein a mixing ratio of the liquid oil to the oil-soluble nutrients in step S4 is 1 kg: (0.005-0.3) g.

9. An easy-to-swallow composite gel prepared by the method according to claim 1.

10. Application of the easy-to-swallow composite gel according to claim 9 in the field of 3D printing, comprising the following steps:
(1) printing: performing 3D printing using the easy-to-swallow composite as a 3D printing material to obtain a printed solid gel;
(2) setting: setting the printed solid gel obtained in step (1) at 0-25° C. for 10-30 minutes to increase the elasticity and water retention of the easy-to-swallow composite gel.
